(19) United States
(12) Patent Application Publication
(10) Pub. No.: US 2014/0283953 A1
(43) Pub. Date: Sep. 25, 2014

(54) METHOD FOR PRODUCING A SOFT MAGNETIC ALLOY STRIP AND RESULTANT STRIP

(71) Applicants: Thierry Waeckerle, Nevers (FR); Remy Batonnet, Decise (FR)

(72) Inventors: Thierry Waeckerle, Nevers (FR); Remy Batonnet, Decise (FR)

(73) Assignee: APERAM, Luxembourg (LU)

(21) Appl. No.: 13/824,222

(22) PCT Filed: Dec. 16, 2011
(86) PCT No.: PCT/FR11/53037

§ 371 Date: Mar. 15, 2013

(51) Int. Cl. H01F 41/02; C22F 1/16; H01F 1/147; C21D 8/12

(52) U.S. Cl. CPC H01F 41/02; C21D 8/1261; C22F 1/16; C21D 8/1233; H01F 1/147
USPC 148/121; 148/651; 148/674; 148/707; 148/311; 148/310; 148/307; 148/313; 148/315; 29/428

(57) ABSTRACT

Method for producing a soft magnetic alloy strip suited to be mechanically cut, having a chemical composition comprising, by weight:

| | | |
|---|---|---|
| 18% ≦ | Co ≦ | 55% |
| 0% ≦ | V + W ≦ | 3% |
| 0% ≦ | Cr ≦ | 3% |
| 0% ≦ | Si ≦ | 3% |
| 0% ≦ | Nb ≦ | 0.5% |
| 0% ≦ | B ≦ | 0.05% |
| 0% ≦ | C ≦ | 0.1% |
| 0% ≦ | Zr + Ta ≦ | 0.5% |
| 0% ≦ | Ni ≦ | 5% |
| 0% ≦ | Mn ≦ | 2% |

the rest being iron and impurities from production, according to which a strip obtained by hot rolling a semi-finished product consisting of the alloy is cold-rolled to obtain a cold-rolled strip with a thickness less than 0.6 mm,

After the cold rolling, the strip is running annealed by passing it through a continuous furnace at a temperature between the order/disorder transition temperature of the alloy and the ferritic/austenitic transformation point of the alloy, followed by rapid cooling to a temperature below 200° C. Strip obtained

This invention concerns the production of a soft magnetic alloy strip of the iron-cobalt type.

Numerous electrotechnical devices include magnetic parts, in particular magnetic yokes made of soft magnetic alloys. This is the case, in particular, with on-board electrical generators in vehicles, in particular in the field of aeronautics, railways, or automobiles. Generally, the alloys used are iron-cobalt alloys, in particular alloys including approximately 50% by weight cobalt. These alloys have the benefit of very high saturation induction, elevated permeability under inductions greater than or equal to 1.6 Tesla, and very high resistance, which allows for reduced alternating current losses at high induction. When in common use, these alloys have a mechanical resistance corresponding to an elasticity limit of approximately 300-500 MPa. However, for certain applications, it is desirable to have alloys with a high elastic limit, which may reach or exceed 600 MPa, or even 900 MPa in some cases. The latter alloys, known as HLE, are particularly useful for producing miniaturised on-board alternators for aeroplanes. These alternators are characterised by very high rotational speeds that may exceed 20,000 rpm, necessitating high mechanical resistance on the part of the components of the magnetic yokes. In order to achieve the characteristics of alloys with high elasticity limit, it was proposed in various patents to add various alloy elements, in particular niobium, carbon, and boron.

All these materials containing 15-55% by weight of cobalt, whether they have a roughly equiatomic Fe—Co composition or more iron than cobalt, must be subjected to annealing suited to obtain the desired usage properties, in particular a good balance between the desired mechanical and magnetic characteristics based on the intended uses. For these alloys, it is known, well established, and practised for electrotechnical parts (stators, rotors, and other various profiles) are cut into strips of hard material obtained by cold rolling up to the final thickness. After cutting, the parts are systematically subjected, in a final step, to static annealing to regulate their magnetic properties. “Static annealing” refers in the prior art of Fe—Co alloys to a thermal treatment in which the cut pieces are kept below 200° C. for at least 1 h, and passed through a temperature greater than or equal to 700° C., at which point a target is reached. In this treatment, the increases and decreases between the environment and the target generally take at least 1 h in an industrial setting. Accordingly, an industrial “static” annealing treatment allowing for good optimisation of the magnetic performance and comprising, to this end, a plateau temperature of one to several hours, takes several hours.

In a manner known, in itself, to persons skilled in the art, cold rolling is carried out on strips having a thickness generally on the order of 2-2.5 mm, obtained by hot rolling and subjected to hyperquench. This allows the order/disorder transformation to be substantially avoided in the material, which, for this reason, remains almost disordered, with few changes compared to its structural state at temperatures greater than 700° C. Due to this treatment, the material may then be cold-rolled without difficulty up to the final thickness.

The strips thus obtained then have sufficient ductility to be cut mechanically. Additionally, when they are intended for the manufacture of magnetic yokes consisting of stacked pieces cut in thin strips, these alloys are sold to users in the form of cold-worked strips. The user then cuts the pieces, stacks them, ensures the mounting or assembly of the magnetic yokes, and then carries out the thermal treatment in the quality necessary to obtain the desired properties. This thermal quality treatment seeks to obtain a certain degree of development of he growth of the grains following recrystallisation, as it is the grain size that determines the balance between mechanical and magnetic performance. Depending on the pieces of the electrotechnical machine in question, the performance balances, and thus the thermal treatments, may be different. Thus, generally, on-board aeronautical generator stators and rotors are cut together in the same portion of the strip in order to minimise metal waste. However, the rotor undergoes thermal treatment to promote very high mechanical performance, whilst the stator undergoes thermal treatment to optimise magnetic performance (i.e., with a greater average grain size).

Furthermore, for each type of cut piece, this thermal quality treatment may include two annealings, one to adjust the magnetic and mechanical properties, as noted above, and the other to oxidise the surfaces of the sheets in order to reduce interlaminar magnetic losses. This second annealing may also be replaced by the depositing of an organic, mineral, or mixed material.

The disadvantages of the prior art method are multiple, including in particular:
The need to change alloys (complicated, larger stocks, more expensive) when one wishes to reach elastic limits of at least 600 MPa;
The need for the user to anneal all cut pieces (whether HLE or not); in fact, following static annealing, the alloy is too fragile to be cut by mechanical means;
The need to tolerate high magnetic losses for elastic limits of at least 500 MPa;
The difficulty, or even impossibility, for HLE performance of reaching a precise balance of mechanical and magnetic performance by means of thermal treatment. In fact, theoretically, it is always possible to obtain HLE performance (500-1200 MPa elasticity limit) by “static annealing” as defined above, by applying temperature plateaus of 700-720° C., i.e., in a metallurgical state going from the hard state to restoration to a more or less crystallised state specific to this type of annealing. However, in practice, in this range 500-1200 MPa, the elastic limit depends on the plateau temperature with one-degree accuracy. This hypersensitivity of performance to the plateau temperature prevents industrial transposition, as industrial static furnaces generally cannot ensure a temperature homogeneity of the batch to be annealed better than +/−10° C., i.e., the range of the setting of the elastic limit is between 500-1200 MPa; exceptionally, this homogeneity may be +/−5° C. However, this is not sufficient for industrial production.
   The difficulty of reaching precise dimensions of the finished part when the final static annealing is applied to the pieces cut in the hard metal with its complex geometry (e.g., E part/profile for an extended-leg transformer).

The aim of this invention is to remedy these disadvantages by proposing a method that allows for the production of a thin soft magnetic alloy strip of the iron-cobalt type, which, based on the same alloy, allows for the provision of an easily cut strip that may also have, in a predefined fashion, an elasticity limit that can be either medium or very high, whilst maintaining the possibility of obtaining good to very good magnetic properties by additionally applying a second static or successive thermal treatment, whereby the alloy is able to pass from a state with a high elasticity limit to a state with a high magnetic performance due to the effects of annealing, e.g., a conventional static annealing; additionally, the mechanical properties of the alloy have high resistance to aging up to 200° C.

To this end, the invention concerns a method for producing a soft magnetic alloy strip suited to be mechanically cut, having a chemical composition comprising, by weight:

| | | |
|---|---|---|
| 18% ≦ | Co ≦ | 55% |
| 0% ≦ | V + W ≦ | 3% |
| 0% ≦ | Cr ≦ | 3% |
| 0% ≦ | Si ≦ | 3% |
| 0% ≦ | Nb ≦ | 0.5% |
| 0% ≦ | B ≦ | 0.05% |
| 0% ≦ | C ≦ | 0.1% |
| 0% ≦ | Zr + Ta ≦ | 0.5% |
| 0% ≦ | Ni ≦ | 5% |
| 0% ≦ | Mn ≦ | 2% |

The rest consisting of iron and impurities resulting from production.

According to this method, a strip obtained by hot rolling from a semi-finished product consisting of the alloy is cold-rolled to obtain a cold-rolled strip having a thickness less than 0.6 mm, and, following the cold rolling, successively annealing the band by passing it through a continuous furnace at a temperature between the order/disorder transition temperature of the alloy and the ferritic/austenitic transformation point of the alloy, followed by rapid cooling to a temperature below 200° C.

The annealing temperature is preferably between 700 and 930° C.

Preferably, the running speed of the strip is such that the strip remains at the annealing temperature for less than 10 min.

Preferably, the cooling speed of the strip upon exiting the treatment furnace is greater than 1000° C./h.

According to the invention, the running speed of the strip through the furnace and the annealing temperature are adjusted to adjust the mechanical resistance of the strip.

Preferably, the chemical composition of the alloy is, e.g.:

| | | |
|---|---|---|
| 47% ≦ | Co ≦ | 49.5% |
| 0.5% ≦ | V ≦ | 2.5% |
| 0% ≦ | Ta ≦ | 0.5% |
| 0% ≦ | Nb ≦ | 0.5% |
| | Cr ≦ | 0.1% |
| | Si ≦ | 0.1% |
| | Ni ≦ | 0.1% |
| | Mn ≦ | 0.1% |

This method has the benefit of allowing for the production of a thin strip that is easily cut by mechanical means, distinguished from known art strips by its metallurgical structure. In particular, the strip obtained by this method is a cold-rolled soft magnetic alloy strip having a thickness below 0.6 mm, consisting of an alloy having a chemical composition comprising the following by weight:

| | | |
|---|---|---|
| 18% ≦ | Co ≦ | 55% |
| 0% ≦ | V + W ≦ | 3% |
| 0% ≦ | Cr ≦ | 3% |
| 0% ≦ | Si ≦ | 3% |
| 0% ≦ | Nb ≦ | 0.5% |
| 0% ≦ | B ≦ | 0.05% |
| 0% ≦ | C ≦ | 0.1% |
| 0% ≦ | Zr + Ta ≦ | 0.5% |
| 0% ≦ | Ni ≦ | 5% |
| 0% ≦ | Mn ≦ | 2% |

The rest consisting of iron and impurities resulting from production, having the following metallurgical structure:

either “partially crystallised”, i.e., on at least 10% of the surface of the samples observed microscopically with ×40 magnification following chemical etching with ferric chloride, it is not possible to identify the grain boundaries;

or “crystallised”, i.e., on at least 90% of the surface of the samples observed microscopically with ×40 magnification following chemical etching with ferric chloride, it is possible to identify a network of grain boundaries and, in the range of grain sizes of 0-60 μm², there is at least one class of grain sizes of 10 μm² in width comprising at least twice as many grains as the same grain size class corresponding to the observation of a cold-rolled comparison strip with the same composition, which has not been subjected to continuous annealing, but did undergo static annealing at a temperature such that the difference between the coercive force obtained with the static annealing and the coercive force obtained with running annealing is less than half of the value of the coercive force obtained by the running treatment, and, in the grain size range of 0-60 μm², there is at least one grain size class 10 μm² wide with a ratio of the number of grains to the total number of grains observed in the successively annealed sample is greater by at least 50% than the same ratio corresponding to a sample taken from the cold-rolled comparison strip that has undergone static annealing.

Preferably, the chemical composition of the soft magnetic alloy is, e.g.:

| | | |
|---|---|---|
| 47% ≦ | Co ≦ | 49.5% |
| 0.5% ≦ | V ≦ | 2.5% |
| 0% ≦ | Ta ≦ | 0.5% |
| 0% ≦ | Nb ≦ | 0.5% |
| | Cr ≦ | 0.1% |
| | Si ≦ | 0.1% |
| | Ni ≦ | 0.1% |
| | Mn ≦ | 0.1% |

and the elasticity limit R 0.2 is 590-1100 MPa, the coercive force Hc 120-900 A/m, magnetic induction B for a 1600 Nm force is 1.5-1.9 Tesla.

With this strip, it is possible to produce pieces for magnetic components, e.g., rotor and stator parts, in particular for magnetic yokes, by directly cutting the parts in a strip according to the invention, and then, if necessary, assembling the parts thus cut so as to form the components such as yokes, subjecting some of them (e.g., stator parts only, or stator yokes), if applicable, to additional annealing in order to optimise the magnetic properties, and in particular to minimise magnetic losses.

The invention further concerns a method for producing a magnetic component, in which a plurality of parts are mechanically cut in a strip obtained by the method, and, following cutting, the parts are assembled to form a magnetic component.

Furthermore, the magnetic component or the parts may be subjected to static quality annealing. i.e., optimisation of the magnetic properties.

Preferably, the static quality annealing or the annealing to optimise the magnetic properties occurs at a temperature of 820-880° C. for a period of 1-5 h.

The magnetic component is, for example, a magnetic yoke.

The invention will now be described more specifically, but without limitation, by reference to examples.

To produce thin cold-rolled strips for the production, by mechanical cutting, of magnetic yoke parts for electrotechnical equipment, an alloy known in itself is used having the following chemical composition by weight: 18% -55% cobalt, 0% -3% vanadium and/or tungsten, 0% -3% chromium, 0% -3% silicon, 0% -0.5% niobium, 0% -0.05% boron, 0% -0.1% C, 0% -0.5% zirconium and/or tantalum, 0% -0.b 5% nickel, 0% -2% manganese, with the rest being iron and impurities from production. Preferably, the alloy contains 47% -49.5% cobalt, 0% -3% of the sum of vanadium and tungsten, 0% -0.5% tantalum, 0% -0.5% niobium, less than 0.1% chromium, less than 0.1% silicon, 0.1% nickel, less than 0.1% manganese. Additionally, the vanadium content must preferably be greater than or equal to 0.5% in order to improve the magnetic properties, and remain less than or equal to 2.5; the tungsten is not indispensable, and the niobium content must preferably be greater than or equal to 0.01% in order to control the growth of the grain at high temperatures, and in order to facilitate the hot transformation. The alloy contains a bit of carbon so that, during production, the deoxidation is sufficient, but the carbon content must remain below 0.1%, and, preferably, below 0.01% to avoid the formation of too many carbides, which deteriorate the magnetic properties. There is no minimum for the content of elements such as Mn, Si, Ni, or Cr. These elements may be absent, but they are generally present due to pollution by the refractories of the production furnace. This alloy is, e.g., the alloy known as AFK 502R, which essentially contains approximately 49% cobalt, 2% vanadium, and 0.04% niobium, with the rest consisting of iron and impurities, as well as small amounts of elements such as C, Mn, Si, Ni, and Cr.

This alloy is produced in a manner known in itself, and cast in the form of semi-finished products such as ingots. To produce a thin strip, a semi-finished product such as an ingot is hot-rolled to obtain a hot strip with a thickness depending on the practical production characteristics. For example, this thickness is generally 2-2.5 mm. At the end of the hot rolling, the strip obtained is subjected to hyperquenching. This treatment allows the order/disorder transformation to be substantially avoided in the material, such that it remains in an almost disordered structural state, with few changes compared to its structural state at temperatures greater than 700° C.; accordingly, it has sufficient ductility to be able to be cold rolled. The hyperquenching thus allows the hot strip to be subsequently cold rolled without difficulty up to the final thickness. The hyperquenching may be carried out directly after the hot rolling if the temperature at the end of rolling is sufficiently high, or, otherwise, after reheating to a temperature greater than the order/disorder transformation point. In practice, the weakening ordering occurs between 720° C. and room temperature, with the metal either rapidly cooled, e.g., with water (typically at a speed greater than 1000° C./min) at the end of hot rolling from a temperature 800-1000° C. to room temperature, or the hot-rolled metal is then slowly cooled, and thus fragile, and reheated to 800-1000° C. before rapid cooling down to room temperature. Such a treatment is known in itself by persons skilled in the art.

After hyperquenching, the hot strip is cold rolled to obtain a cold strip with a thickness below 1 mm, preferably below 0.6 mm, generally 0.5-0.2 mm, which may go down to 0.05 mm.

After producing the hard cold-rolled strip, it undergoes successive annealing in a treatment oven, at a temperature such that the alloy is in the disordered ferritic phase. This means that the temperature is between the order/disorder transformation point and the ferritic/austenitic transformation point. For an iron-cobalt alloy with a cobalt content 45-55% by weight, the annealing temperature must be 700-930° C. The successive annealing temperature range may extend in the lower range as the cobalt content approaches 18%. For example, at 27% cobalt, the annealing temperature is preferably between 500 and 950° C. Persons skilled in the art can determine this annealing temperature based on the composition of the alloy.

The speed of passage through the oven may be adjusted taking into account the length of the oven, so that the passage time in the homogeneous temperature area of the oven is less than 10 min, preferably 1-5 min. In any case, the time for which the treatment temperature is maintained should be greater than 30 s. For an industrial oven with a length of approximately one metre, the speed must be greater than 0.1 m per minute. For another type of industrial oven 30 m long, the speed of passage must be greater than 2 metres/minute, preferably 7-40 m/min. Generally, persons skilled in the art know how to adjust the speeds of passage based on the length of the available ovens.

It should be noted that any kind of treatment oven may be used. In particular, it may be a conventional resistance oven or a thermal radiation oven, a Joule-effect annealing furnace, a fluidised bed annealing system, or any other type of oven.

Upon exiting the oven, the strip must be cooled at a high enough speed to avoid a total order-disorder transformation. However, the inventors were surprised to find that, unlike a 2 mm thick strip that must be hyperquenched to be then cold rolled, a thin strip (0.1-0.5 mm) intended for processing, stamping, punching is only subject to partial ordering, resulting in only a low degree of fragility, such that hyperquenching is not necessary.

The inventors were also surprised to find that, at the end of successive annealing as described above, the cuttability of the strip becomes very good, as the disorder/order transformation is not total. This means, unexpectedly, that such a strip can be cut mechanically despite partial ordering resulting in a certain degree of fragility.

For the disorder/order transformation not to be total, the cooling speed must be greater than 1000° C./h, and, preferably, greater than 2000° C./h above 200° C. The cooling speed may as elevated as theoretically possible taking into account the thickness of the strip and the means of cooling available. However, it is practically not useful to exceed 10000° C./h, and a speed of 2000-3000° C./h is generally sufficient.

The inventors surprisingly found that, with such a running treatment, contrary to what is found with static treatments that allow for comparable mechanical or magnetic properties to be obtained, strips are obtained with sufficient ductility to be stacked and form magnetic yokes or any other magnetic component.

The inventors also found that, by adjusting the passage time through the oven, it is possible to adjust the mechanical characteristics obtained in the strip, such that, based on a standard iron-cobalt alloy, it is just as possible to obtain alloys with the usual mechanical characteristics, i.e., an elasticity limit of 300-500 MPa, as alloys with high elasticity limits (HLE), i.e., an elasticity limit greater than 500 MPa, preferably 600-1000 MPa, and may reach 1200 MPa. Obviously, these thermal treatments lead to very different magnetic properties, in particular with regard to magnetic losses. The standard iron-cobalt alloy is, e.g., an AFK 502R iron-cobalt alloy essentially containing 49% cobalt, 2% vanadium, and 0.04% Nb, the rest being iron and impurities.

The inventors have found that this combination of unusual performances, i.e., cuttability in the annealed state, whilst fixing the elastic limit as desired between 300 and 1200 MPa, were closely related to the particular metallurgic structure obtained by the continuous annealing according to the invention, which is different to the metallurgic structure arising from static annealing. This concerns, in particular, the rate of crystallisation, and, for sufficiently crystallised materials, the grain size distribution, which is very different to that obtained with static annealing that allows for the same use properties of a material.

Below, the effects of the successive thermal treatment and the conditions under which it is carried out on the mechanical and magnetic properties of a 50% cobalt alloy will be discussed more specifically based on a series of trials.

Laboratory trials were conducted, on the one hand, on an alloy with a non-standard composition, AFK502NS (heat JB 990), containing 48.6% Co-1.6% V-0.119% Nb-0.058% Ta-0.012% C, with the rest being iron and impurities, and a conventional alloy quality of the type AFK 502 R (heat JD173), i.e., a standard alloy containing 48.6% Co-1.98% V-0.04% Nb-0.007% C, the rest being iron and impurities. These alloys, which were first produced in the form of cold-rolled strips 0.2 mm in thickness were subjected to thermal treatments on passing through a hot oven and held during one minute at a temperature of 785, 800, 840, and 880° C., respectively. These thermal treatments, which allow for the simulation of an industrial running thermal treatment, were carried out under argon and followed by rapid cooling at a speed of 2000-10,000° C./h, somewhat more specifically 6000+/−3000° C./h, taking into account the imprecision of the determination of this type of speed and the non-uniformity of the cooling speed between the plateau temperature and 200° C. or room temperature. These trials provided the results shown in table 1.

In the table:
T: Is the annealing temperature in ° C.
B 1600: Is the magnetic induction expressed in Tesla for a magnetic field of 1600 Am (approximately 20 Oe).
Br/Bm: Is the ratio of the residual magnetic induction Br to the maximum magnetic induction Bm obtained upon the magnetic saturation of the sample.
Hc: Is the coercive force in A/m
Losses: The magnetic losses in W/kg dissipated by the currents induced when the sample is subjected to a variable magnetic field that, in this case, is an alternative field with a frequency of 400 Hz, inducing an alternative sinus induction due to the use of an electronic offset of the magnetic field applied, known in itself to persons skilled in the art, having a maximum value of 2 Tesla.
R0.2: The conventional elasticity limit measured in pure traction on normalised samples.

TABLE 1

| | | | B1600 | | Hc | Losses | R0.2 |
|---|---|---|---|---|---|---|---|
| Quality | Flow | T (° C.) | (Tesla) | Br/Bm | (A/m) | (W/kg) | (MPa) |
| AFK502R | JD173 | 785 | 1.5850 | 0.83 | 822 | 339 | 990 |
| (standard) | | 800 | 1.6230 | 0.80 | 629 | 272 | 890 |
| | | 840 | 1.7560 | 0.49 | 183 | 106 | 660 |
| | | 880 | 1.7500 | 0.40 | 130 | 85 | 600 |
| AFK502NS | JB990 | 785 | 1.5180 | 0.81 | 883.3 | 381 | 1090 |
| (non- | | 800 | 1.5490 | 0.80 | 779.96 | 336 | 970 |
| standard) | | 840 | 1.7260 | 0.64 | 306.40 | 156 | 760 |
| | | 880 | 1.8080 | 0.45 | 148 | 95.5 | 620 |

Following thermal treatment, mechanical cutting trials were carried out using punches and matrices. These results show that, following successive annealing, it is possible to cut the parts in satisfactory conditions without apparent signs of fragility just as well with the non-standard quality of the composition AFK 502NS as with the classic or standard quality, AFK 502 R. It was also found that, by adjusting the successive annealing temperature between 785 and 880° C., it is possible to obtain mechanical properties with high elastic limits just as well for alloy AFK502NS as for classic alloy AFK502R, and that the mechanical characteristics obtained are very comparable. Accordingly, it appears that it is not necessary to use two distinct qualities to obtain alloys with high elasticity limits or alloys with common elasticity limits, i.e., to produce parts in HLE or common elasticity limit alloys.

Furthermore, these results show that the magnetic properties, including the losses measured under an alternative field with a maximum amplitude of 2 Tesla and a frequency of 400 Hertz, are quite comparable. It was additionally found that the relationship between magnetic losses and the elasticity limit for sheets 0.20 mm thick, measured on washers cut in the annealed strip are quite comparable.

On these materials, in the condition following the aforementioned annealing, a high-temperature annealing was also carried out, known as “static optimisation annealing”, to optimise the magnetic characteristics. This annealing was carried out on statically annealed washers at a temperature of 850° C. for three hours. The results obtained with this static optimisation annealing are shown in table 2 below.

TABLE 2

| | | | | | | Losses |
|---|---|---|---|---|---|---|
| | | | | | | (W/kg) |
| | | | B 1600 | | Hc | 2T- |
| Quality | Flow | T (° C.) | (Tesla) | Br/Bm | (A/m) | 400 Hz |
| AFK502R | JD173 | 785 | 2.2110 | 0.69 | 51.7 | 36.0 |
| standard | | 800 | 2.2040 | 0.69 | 50.9 | 35.5 |
| | | 840 | 2.1970 | 0.66 | 50.9 | 35.0 |
| | | 880 | 2.2010 | 0.67 | 53.3 | 34.0 |
| AFK502NS | JB990 | 785 | 2.2140 | 0.78 | 62.1 | 52.0 |
| non- | | 800 | 2.2040 | 0.74 | 58.9 | 53.5 |
| standard | | 840 | 2.2140 | 0.78 | 62.1 | 54.0 |
| | | 880 | 2.2190 | 0.79 | 62.9 | 51.0 |

Based on these results, it can be said that the magnetic losses at 400 Hz under a 2 Tesla field are considerably reduced, and, more generally, that all of the magnetic properties obtained practically do not depend on the successive annealing temperature. These properties are also nearly identical to the properties obtained on washers extracted from strips 0.2 mm thick that were not successively annealed, but directly subjected to the same static optimisation annealing, corresponding to the prior art.

These results show that successive annealing provides a benefit to the material type AFK 502 R (classic quality): In fact, with this material, it is possible to produce pre-annealed strips with HLE characteristics, which, additionally, can be cut and formed in this pre-annealed state.

Additionally, it is seen that the balance of mechanical/magnetic properties can be adjusted by the successive annealing temperature. Accordingly, an alloy with the chemical composition of these examples can be used by a customer wishing to produce both parts with high mechanical characteristics and common mechanical characteristics, and who may only carry out the static optimisation annealing on the pieces cut in order simply to optimise the magnetic losses, if necessary.

Furthermore, a series of trials were carried out on strips in AFK 502R industrial alloy with standard composition, hardened at a thickness of 0.35 mm. Over the course of these trials, successive annealing treatments were carried out at different passage speeds in an industrial oven with a useful length of 1.2 m. Useful length refers to the length of the oven in which the temperature is sufficiently homogeneous to correspond to the annealing temperature target.

The chemical compositions used in the samples used are listed in table 3. In this table, all elements are not indicated, and persons skilled in the art will understand that the rest is iron and impurities resulting from production, as well as, possibly, small amounts of elements such as carbon.

TABLE 3

| | Bench | | | | | | | |
|---|---|---|---|---|---|---|---|---|
| Flow | mark | Co | V | Nb | Mn | Cr | Si | Ni |
| No. 1 | JD842 | 48.61 | 1.99 | 0.041 | 0.027 | 0.015 | 0.016 | 0.04 |
| No. 2 | JE686 | 48.49 | 2.00 | 0.037 | 0.042 | 0.031 | 0.061 | 0.10 |
| No. 3 | JE798 | 48.01 | 1.99 | 0.041 | 0.043 | 0.040 | 0.057 | 0.16 |
| N^{o}4 | JE799 | 48.51 | 1.96 | 0.040 | 0.035 | 0.028 | 0.051 | 0.06 |
| N^{o}5 | JE872 | 48.45 | 1.98 | 0.041 | 0.043 | 0.049 | 0.069 | 0.14 |

The passage speeds were selected such that each of these treatments corresponds to a time spent above 500° C., the start of the restoration temperature, of significantly less than 10 min.

The successive annealings were carried out at three passage speeds: 1.2 m/min to obtain the magnetic and mechanical properties corresponding to use to produce magnetic stator yokes for which low-to-medium magnetic loss levels are desired; a speed of 2.4 m/min to obtain mechanical characteristics suitable for the production of magnetic rotor yokes, and 3.6 and 4.8 m/min to obtain mechanical characteristics corresponding to HLE quality. Furthermore, for comparative purposes, static annealing at a temperature of 760° C. was carried out for two hours on samples. This annealing was conventional “static optimisation annealing”, providing properties comparable to those of running annealing at a speed of 1.2 m/min at 880° C. Lastly, for the highest successive annealing temperature (800° C.), the speed was further reduced (within the limits of a 10 min target) in order to further reduce magnetic losses and the elasticity limit. In fact, for certain applications, quite low magnetic losses may be required for the stator. These results show that this in fact allows for R0.2 to be reduced below 400 MPa, which is useful as an extended adjustment range of the elasticity limit by simple adjustment of the speed. On the other hand, the magnetic losses are not reduced compared to the approximate speed value. Additionally, if one wishes to reduce magnetic losses significantly, it is necessary to carry out an additional static magnetic optimisation annealing, as shown in the results of table 2.

The results of the trials carried out with flow no. 1 JD 842 are shown in table 4; those obtained with the other flows are comparable.

These results show that it is possible to adjust the elasticity limit R 0.2 within a very broad range of values between 400 MPa and 1200 MPa by varying the annealing parameters, i.e., speed, i.e., the duration of high temperature exposure, and the annealing temperature, under satisfactory conditions for industrial production. In fact, the properties obtained vary sufficiently slowly with the treatment parameters for it to be possible to manage industrial production. These results also show that there is a strong correlation between the elasticity limit, the coercive force, and the various other properties of the alloy.

Additionally, these trials allowed for the identification of the effects of thermal treatments on the metallographic structure of the alloy produced by the method of the invention. The trials were conducted, in particular, on flow JD 842. The measurements were taken, in particular, on a sheet that had been subjected to running annealing at 880° C. at various speeds. The temperature of 880° C. was chosen because it corresponds to the optimum for obtaining good magnetic properties, i.e., a temperature allowing for both low magnetic loss values and a broad range of elasticity limits (e.g., 300-800 MPa) by simply varying the speed with values that only leave the alloy in the target temperature area for a few minutes (<10 min).

TABLE 4

| Running | | | | | | | |
|---|---|---|---|---|---|---|---|
| annealing | | | | | Losses (W/kg) | | |
| conditions | | DC | | | at 400 Hz | | |
| T_{RD} | V | B1600 | | Hc | B = 1.5 | B = 2 | R0.2 |
| (° C.) | (m/min) | (Tesla) | Br/Bm | (A/m) | Tesla | Tesla | (MPa) |
| 760° C. | 1.2 | 1.6750 | 0.69 | 321 | 111 | 205 | 665 |
| | 2.4 | 1.5400 | 0.83 | 907 | 252 | 420 | 1030 |
| | 3.6 | 1.5250 | 0.84 | 939 | 264 | 443 | 1140 |
| | 4.8 | 1.5250 | 0.84 | 907 | 255 | 414 | 1230 |
| 785° C. | 1.2 | 1.7700 | 0.48 | 127 | 65 | 125 | 540 |
| | 2.4 | 1.7050 | 0.75 | 446 | 135 | 245 | 760 |
| | 3.6 | 1.5300 | 0.83 | 915 | 255 | 430 | 1060 |
| | 4.8 | 1.5300 | 0.86 | 915 | 260 | 432 | 1200 |
| 810° C. | 1.2 | 1.7350 | 0.46 | 122 | 66 | 125 | 540 |
| | 2.4 | 1.7750 | 0.53 | 151 | 71 | 137 | 580 |
| | 3.6 | 1.6400 | 0.76 | 549 | 163 | 286 | 830 |
| | 4.8 | 1.5200 | 0.84 | 947 | 266 | 438 | 1140 |
| 840° C. | 1.2 | 1.7250 | 0.40 | 107 | 63 | 119 | 500 |
| | 2.4 | 1.7600 | 0.47 | 117 | 65 | 121 | 530 |
| | 3.6 | 1.7400 | 0.66 | 255 | 94 | 176 | 710 |
| | 4.8 | 1.5400 | 0.81 | 820 | 230 | 382 | 1000 |
| 880° C. | 0.6 | 1.210* | 0.45 | 95 | | 108 | 390 |
| | 1.2 | 1.5050* | 0.45 | 94 | | 95 | 435 |
| | 2.4 | 1.5800* | 0.57 | 89 | | 103 | 495 |
| | 4.8 | 8.850* | 0.68 | 392 | | | 845 |

*B = For an 800 A/m field

To study the metallographic structures, micrographic observations were made on samples taken from the strips so as to observe the slice of the rolled strips perpendicular to the direction of rolling. On these samples, micrographs were taken with immersion etching for 5 s in a ferric chloride bath at room temperature containing (for 100 ml): 50 ml FeCl3 and 50 ml water following polishing with paper 1200 and electrolysis with an A2 bath consisting (for 1 litre) of 78 ml perchloric acid, 120 ml distilled water, 700 ml ethyl alcohol, 100 ml butyl glycol.

These observations were made with an optical microscope with a magnification of 40. It was found that, for low annealing speeds, i.e., 1.2 m/min, the structure is similar to that observed on materials subjected to static annealing. This is an isotropic crystallised structure. For the static annealing, the structure is apparently 100% crystallised, and the grain boundaries are perfectly defined. For running annealings at 785° C., the structure is partially crystallised (the grain boundaries are not very well defined), and for successive annealing at 880° C., the structure is more crystallised, but the grain boundaries are still not visible enough to determine whether these samples are 100% crystallised.

For the highest speeds, i.e., speeds of 2.4 m/min, 3.6 m/min, and 4.8 m/min.

The micrographs show a very specific, very distinct structure of the structures obtained by static annealing. It is a structure that is apparently close to that of cold-worked metal. The inventors also found that the micrographs taken of materials successively annealed at 880° C. at a speed of 4.8 m/min had a very anisotropic structure (highly elongated grains), much more anisotropic than the structure obtained by annealing at 785° C. at a speed of 4.8 m/min.

Thus, it appears that, with the successive thermal treatments, it is possible to obtain two types of structures:

on the one hand, a specific anisotropic structure obtained by passages at the highest speeds (2.4 m/min, 3.6 m/min, and 4.8 m/min). This structure is a restored or partially crystallised structure, which can be confirmed by an X-ray examination showing that the texture is that of a restored, slightly recrystallised material, very similar to the hardening texture;

on the other hand, a structure with an appearance similar to that obtained by static annealing, corresponding to successive annealing at low speed (1.2 m/min and 0.6 m/min). This is an entirely crystallised structure, as is confirmed by an X-ray examination, with a texture very close to that of metal recrystallised in static annealing.

The grain size was also determined on these different samples. Because the coercive force of a magnetic alloy is closely related to grain size, in order to make significant comparisons between two means of treating the same material, it is necessary to make observations on materials with equivalent coercive forces. Additionally, in order to take these measurements, samples were chosen with close coercive forces, and measurements were taken, on the one hand on a material that had been subjected to static annealing at 760° C. for 2 h, and, on the other hand, for a material successively annealed at 880° C. at a speed of 1.2 m/min.

The grains were scored using automatic image analysis equipment allowing for detection of the grain contours, calculation of the perimeter of each one, conversion of this perimeter into an equivalent diameter, and, lastly, calculation of the surface area of the grain. This device also allows for a total number of grains, as well as their surface area, to be obtained. Such automatic image analysis devices for grain scoring are known in themselves. In order to obtain results with satisfactory statistical significance, the scoring was carried out on a plurality of sample areas. The scoring was carried out by defining the following grain size classes:

grains with a surface area of 10 μm²-140 μm² at intervals of 10 μm².

grains with a surface area of 140 μm²-320 μm² at intervals of 20 μm².

grains with a surface area of 320 μm²-480 μm² at intervals of 40 μm².

grains with a size of 480 μm²-560 μm², grains with a size of 560 μm²-660 μm², grains with a size of 660 μm²-800 μm², grains with a size of 800 μm²-1000 μm², grains with a size of 1000 μm²-1500 μm², grains with a size exceeding of 1500 μm².

These examinations show that static annealing at 760° C. is characterised by a Gaussian grain size distribution with a peak around 150 μm². The grains of this size represent 5.5% of the total surface area of a sample analysed. There are very few large grains, and the grain sizes remains below 750 μm².

On the other hand, the continuously annealed materials show a structure in which there are fewer small grains, but more large grains between 200 and 1000 μm². In particular, grains between 30 and 50 μm² occupy a surface area equivalent to that occupied by two large grains with sizes between 500 and 1100 μm².

These results show that, although apparently comparable to a structure obtained by static annealing, continuous annealing leads to a very different structure, in particular in terms of grain size distribution.

Additionally, grains were scored on four strips 0.34 mm thick that, on the one hand, had been successively annealed at 880° C. under hydrogen at a speed of 1.2 m/min, and, on the other, static optimisation annealing at 760° C. for two hours under hydrogen. These strips correspond to flows JE 686, JE798, JD 842, JE 799, and JE 872, the compositions of which are listed in table 3. These examinations show that, for these flows, the distribution of the finest grains, in particular those less than 80 μm² in size, is quite different for the samples subjected to static classification annealing at 760° C. than to those resulting from successive treatment at 880° C. In particular, the fine grains are much more numerous on the samples subjected to static annealing than the samples subjected to running annealing. It will be noted in particular, that, for grains smaller than 40 μm², the number of grains, by size class, on the samples subjected to static annealing is greater than the maximum number of grains obtained on running annealed samples. Overall, the results show that, in particular with running annealing, the grain size distribution shows no dominant grain size. The maximum number of grains found in a grain size class never exceeds 30, unlike static annealing, where the number of grains may reach 160 for a single size class, in particular small grains.

For each of the samples, the total number of grains for a surface area of 44 200 mm², as well as the average size of the grains, were also determined. These results are shown in table 5.

TABLE 5

| | | Average grain | Total number |
|---|---|---|---|
| Flow | Annealing | size (μm²) | of grains |
| JD842 | Static 760° C./2 h | 94 | 454 |
| | Running | 155 | 260 |
| | 880° C./1.2 m/min | | |
| JE686 | Static 760° C./2 h | 104 | 332 |
| | Running | 175 | 204 |
| | 880° C./1.2 m/min | | |
| JE872 | Static 760° C./2 h | 58 | 563 |
| | Running | 145 | 243 |
| | 880° C./1.2 m/min | | |
| JE798 | Static 760° C./2 h | 51 | 634 |
| | Running | 168 | 211 |
| | 880° C./1.2 m/min | | |
| JE799 | Static 760° C./2 h | 78 | 427 |
| | Running | 127 | 243 |
| | 880° C./1.2 m/min | | |

These results show, in particular, that the samples subjected to running annealing at 880° C. at a speed of 1.2 m/min have an average grain size greater than 110 à μm² and an average number of grains less than 300, whilst the samples subjected to static annealing at 760° C. for 2 h have average grain sizes less than 110 μm² and a number of grains greater than 300. These characteristics allow for the clear identification or distinction of the structures obtained, on the one hand, by running annealing, and, on the other, by static annealing. More generally, the inventors found that the types of treatment could be distinguished by the following grain size characteristics:

either the structure is “partially crystallised”, i.e., at least 10% of the surface of the samples observed microscopically with ×40 magnification following chemical etching with ferric chloride, it is not possible to identify the grain boundaries;

or “crystallised”, i.e., at least 90% of the surface of the samples observed microscopically with ×40 magnification following chemical etching with ferric chloride, it is possible to identify a network of grain boundaries and, in the range of grain sizes of 0-60 μm², there is at least one class of grain sizes of 10 μm² in width comprising at least twice as many grains as the same grain size class corresponding to the observation of a cold-rolled comparison strip with the same composition, which has not been subjected to continuous annealing, but did undergo static annealing at a temperature such that the difference between the coercive force obtained with the static annealing and the coercive force obtained with running annealing is less than half of the value of the coercive force obtained by the running treatment, and, in the grain size range of 0-60 μm², there is at least one grain size class 10 μm² wide with a ratio of the number of grains to the total number of grains observed in the running annealed sample is greater by at least 50% than the same ratio corresponding to a sample taken from the cold-rolled comparison strip that has undergone static annealing.

Cutting tests were also carried out on these samples. To this end, stators were cut on samples that, according to the invention, were successively annealed at temperatures of 785, 800, and 840° C. at speeds of 1.2 m/min for a useful oven length of 1.2 m, corresponding to an exposure time to the annealing temperature of one minute. These cuts were made on industrial cutting systems by punching using a punch and a matrix. The cuts were made on strips 0.20 mm and 0.35 mm thick.

The quality of the cut was determined by evaluating the cutout radius and the presence or absence of burrs. These results are shown in table 6. The results show that, no matter what the thickness and running annealing temperature, the cut quality is satisfactory.

TABLE 6

| | | Running | | | | |
|---|---|---|---|---|---|---|
| | Thickness | annealing | Hardness | Cutout | | Customer |
| Flow | (mm) | temperature | Hv0.2 | radius | Burrs | validation |
| JD414 | 0.20 mm | 785° C. | 185 | RAS | RAS | Ok |
| | | 800° C. | 180 | RAS | RAS | Ok |
| | | 840° C. | 173 | RAS | RAS | Ok |
| | 0.35 mm | 785° C. | 179 | Greater | Close to | Ok |
| | | | | than hard | hard state | |
| | | | | state | | |
| | | 800° C. | 176 | Less | Greater | Ok |
| | | | | pronounced | than hard | |
| | | 840° C. | 172 | Less | Greater | Ok |

The deformities following thermal quality treatment were also examined on the cut parts.

In fact, for certain parts, in particular for E-shaped parts, it was found that the final treatment of the parts obtained by a prior art method can lead to deformities, probably arising from the recrystallisation and transformation of the rolled texture into recrystallisation temperature. These deformities lead to size variations on the order of a few tenths of a mm, which are not acceptable. For E profiles, for example, where the legs of the E have a length of several tens of cm, which is large compared to the other dimensions of the E, after optimisation annealing, variations in the distance between neighbouring legs on the order of 1-5 mm between top and bottom of the legs (distance difference) are observed.

To the contrary, with the alloy successively annealed according to the invention in a crystallised or partially crystallised state, an additional static annealing to optimise magnetic properties—typically at 850° C. for 3 h—generally does not significantly affect the geometry of the parts. Tests on E-shaped parts have shown that the size variations arising from static magnetic optimisation annealing remain below 0.05 mm in the above example of E-shaped profiles, which is entirely acceptable.

Lastly, aging tests were carried out at 200° C. with holding times of 100 h and 100 h+500 cumulative hours. These trials were carried out at 200° C. because this temperature corresponds approximately to the maximum temperature to which materials forming cylinder heads of turning electrotechnical machines used in normal operating conditions can be exposed. To this end, trials were carried out with an AFK 502 R alloy for two standard qualities corresponding to static 760° C. annealings for 2 h and 850° C. for 3 h, and for strips according to the invention corresponding to running annealings at 880° C. for three speeds: 1.2 m/min, 2.4 m/min, and 4.8 m/min in an oven with a useful length of 1.2 m. During these trials, B 1600 was measured as the magnetic induction for a field of 1600 A/m, the Br/Bm ratio of the residual magnetic induction to the maximum magnetic induction, and the coercive force H_{C}. These results are shown in table 7.

TABLE 7

| | Aging time at | B 1600 | | Hc |
|---|---|---|---|---|
| Annealing | 200° C. | (Tesla) | Br/Bm | (A/m) |
| Static at | 0 h | 2.2070 | 0.71 | 97 |
| 760° C./2 h | 100 h | 2.1700 | 0.75 | 102 |
| | 100 h + 500 h | 2.1600 | 0.75 | 107 |
| Static at | 0 h | 2.2500 | 0.62 | 45 |
| 850° C./3 h | 100 h | 2.1850 | 0.68 | 58 |
| | 100 h + 500 h | 2.2000 | 0.69 | 58 |
| Running 880° C. | 0 h | 1.8200 | 0.55 | 83 |
| v = 1.2 m/min | 100 h | 1.7700 | 0.48 | 88 |
| | 100 h + 500 h | 1.7750 | 0.49 | 85 |
| Running 880° C. | 0 h | 1.7650 | 0.41 | 96 |
| v = 2.4 m/min | 100 h | 1.8250 | 0.57 | 75 |
| | 100 h + 500 h | 1.8350 | 0.59 | 74 |
| Running 880° C. | 0 h | 1.6450 | 0.82 | 684 |
| v = 4.8 m/min | 100 h | 1.6650 | 0.83 | 652 |
| | 100 h + 500 h | 1.6600 | 0.83 | 644 |

The results show that, for the statically annealed samples, the induction B for a 1600 Nm field decreases by 2%, whilst the coercive force Hc increases by 10% (thermal treatment at 760° C.) or 25% (thermal treatment at 850° C.).

For running annealed samples, the induction B for a field of 1600 Nm varies no more than 2%, and the coercive force Hc no more than 23%.

These results show that running annealed alloys are no more sensitive to aging than statically annealed alloys. Thus, with an alloy as defined above, i.e., containing 18-55% Co, 0-3% V+W, 0-3% Cr, 0-3% Si, 0-0.5% Nb, 0-0.05% B, 0- . . . % C, 0-0.5% Ta+Zr, 0-5% Ni, 0-2% Mn, the rest consisting of iron and impurities from production, in particular an alloy of type AFK502R, magnetic components, in particular, magnetic shielding can be produced by mechanically cutting parts in continuously cold-rolled strips in order to obtain the desired mechanical characteristics, taking into account the intended application, and, depending on the application, (not) carrying out additional quality annealing on the cut pieces, which may be assembled, in order to optimise the magnetic properties of the alloy.

For each application and each specific alloy, persons skilled in the art know how to determine the desired mechanical and magnetic characteristics, and how to determine the particular conditions of the various thermal treatments. Obviously, cold-rolled strips are obtained by cold rolling hyperquenched hot-rolled strips to preserve an essentially disordered structure. Persons skilled in the art know how to produce such hot-rolled strips.

Additionally, a thermal oxidation treatment may be carried out in order to ensure the electrical insulation of the parts of a stack, as is known to persons skilled in the art.

Persons skilled in the art will understand the value of this product, which, on the one hand, allows for reduction of the number of alloy qualities necessary to meet the needs of users, and, on the other hand, to very significantly reduce the number of static thermal treatments to be carried out on the cut parts.

Furthermore, persons skilled in the art will understand that the chemical compositions indicated merely define the essential elements, some of which may or may not be present. The minimum contents of optional elements are set at 0%. However, these elements may always be present at least in trace amounts more or less detectable with known analytical methods.

1. A method for producing a soft magnetic alloy strip suited to be mechanically cut, having a chemical composition comprising, by weight:

| | | |
|---|---|---|
| 18% ≦ | Co ≦ | 55% |
| 0% ≦ | V + W ≦ | 3% |
| 0% ≦ | Cr ≦ | 3% |
| 0% ≦ | Si ≦ | 3% |
| 0% ≦ | Nb ≦ | 0.5% |
| 0% ≦ | B ≦ | 0.05% |
| 0% ≦ | C ≦ | 0.1% |
| 0% ≦ | Zr + Ta ≦ | 0.5% |
| 0% ≦ | Ni ≦ | 5% |
| 0% ≦ | Mn ≦ | 2% |

and the rest consisting of iron and impurities from production, the said method comprising:
hot rolling a semi-finished product consisting of the alloy
cold rolling the semi-finished product to obtain a cold-rolled strip with a thickness less than 0.6 mm,
wherein, after the cold rolling, the strip is running annealed by passing it through a continuous furnace at a temperature between the order/disorder transition temperature of the alloy and the ferritic/austenitic transformation point of the alloy, followed by rapid cooling to a temperature below 200° C.

2. The method according to claim 1, wherein the annealing temperature is 700-930° C.

3. Method according to claim 1, the speed of the passage of the strip is such that the strip remains at the annealing temperature for less than 10 min.

4. The method according to claim 1, characterised in that the cooling speed of the band upon exiting the treatment furnace is greater than 1000° C./h.

5. The method according to claim 1, wherein the speed of the passage of the strip through the furnace and the annealing temperature are adjusted to adjust the mechanical resistance of the strip.

6. The method according to claim 1, wherein the chemical composition of the alloy is such that:

| | | |
|---|---|---|
| 47% ≦ | Co ≦ | 49.5% |
| 0.5% ≦ | V ≦ | 2.5% |
| 0% ≦ | Ta ≦ | 0.5% |
| 0% ≦ | Nb ≦ | 0.5% |
| | Cr ≦ | 0.1% |
| | Si ≦ | 0.1% |
| | Ni ≦ | 0.1% |
| | Mn ≦ | 0.1%. |

7. Cold-rolled soft magnetic alloy strip having a thickness below 0.6 mm, comprising an alloy having a chemical composition comprising the following by weight:

| | | |
|---|---|---|
| 18% ≦ | Co ≦ | 55% |
| 0% ≦ | V + W ≦ | 3% |
| 0% ≦ | Cr ≦ | 3% |
| 0% ≦ | Si ≦ | 3% |
| 0% ≦ | Nb ≦ | 0.5% |
| 0% ≦ | B ≦ | 0.05% |
| 0% ≦ | C ≦ | 0.1% |
| 0% ≦ | Zr + Ta ≦ | 0.5% |
| 0% ≦ | Ni ≦ | 5% |
| 0% ≦ | Mn ≦ | 2% |

and the rest consisting of iron and impurities from production,
wherein:
either the structure is “partially crystallised”, i.e., at least on 10% of the surface of the samples observed microscopically with x 40 magnification following chemical etching with ferric chloride, it is not possible to identify the grain boundaries;
or “crystallised”, i.e., at least on 90% of the surface of the samples observed microscopically with ×40 magnification following chemical etching with ferric chloride, it is possible to identify a network of grain boundaries and, in the range of grain sizes of 0-60 μm², there is at least one class of grain sizes of 10 μm² in width comprising at least twice as many grains as the same grain size class corresponding to the observation of a cold-rolled comparison strip with the same composition, which has not been subjected to continuous annealing, but did undergo static annealing at a temperature such that the difference between the coercive force obtained with the static annealing and the coercive force obtained with successive annealing is less than half of the value of the coercive force obtained by the running treatment, and, in the grain size range of 0-60 μm², there is at least one grain size class 10 μm² wide with a ratio of the number of grains to the total number of grains observed in the running annealed sample is greater by at least 50% than the same ratio corresponding to a sample taken from the cold-rolled comparison strip that has undergone static annealing.

8. Soft magnetic alloy strip according to claim 7, wherein the chemical comparison is such that:

| | | |
|---|---|---|
| 47% ≦ | Co ≦ | 49.5% |
| 0.5% ≦ | V ≦ | 2.5% |
| 0% ≦ | Ta ≦ | 0.5% |
| 0% ≦ | Nb ≦ | 0.5% |
| | Cr ≦ | 0.1% |
| | Si ≦ | 0.1% |
| | Ni ≦ | 0.1% |
| | Mn ≦ | 0.1% |

and that the elasticity limit Rₑ 0.2 is 590-1100 MPa, the coercive force Hc is 120-900 A/m, magnetic induction B for a 1590 A/m force is 1.5-1.9 Tesla.

9. A method for producing a magnetic component comprising:
mechanically cutting a plurality of parts in a strip according to claim 7, and
assembling the parts are assembled to form a magnetic component.

10. The method according to claim 9, characterised in that the magnetic component is further subjected to static annealing to optimise its magnetic properties.

11. The method according to claim 10, characterised in that the static annealing to optimise the magnetic properties occurs at a temperature of 820-880° C. for a target period of 1-5 h.

12. The method according to claim 9, characterised in that the magnetic component is a magnetic yoke.
